(19) United States
(12) Patent Application Publication
(10) Pub. No.: US 2011/0144348 A1
(43) Pub. Date: Jun. 16, 2011

(54) VOLTAGE-SENSITIVE DYE AND METHOD OF PREPARING THE SAME

(75) Inventors: Nam Seob BAEK, Daejeon (KR); Yong Hee KIM, Daejeon (KR); Sang Don JUNG, Daejeon (KR); Myung Ae CHUNG, Daejeon (KR); Ji Hyun LEE, Nonsan (KR); Gook Hwa KIM, Jeonju (KR)

(73) Assignee: Electronics and Telecommunications Research Institute, Daejeon (KR)

(21) Appl. No.: 12/878,666

(22) Filed: Sep. 9, 2010

(30) Foreign Application Priority Data
Dec. 16, 2009 (KR) 10-2009-0125438

(51) Int. Cl. C09B 49/04

(52) U.S. Cl. 546/334

(57) ABSTRACT

Provided is a voltage sensitive dye represented by Formula 7.

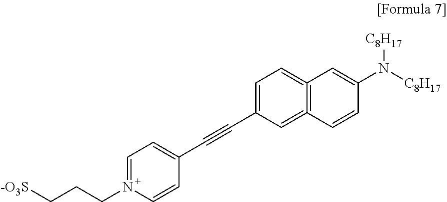

Through connection of an electron donor with an electron acceptor by a triple bond, the voltage sensitive dye has a lower free rotation rate in molecular structures of the electron donor and the electron acceptor (e.g., photoisomerization), and thus fluorescence efficiency and voltage sensitivity to external electron stimulation can be improved.

### CROSS-REFERENCE TO RELATED APPLICATION

This application claims priority to and the benefit of Korean Patent Application No. 10-2009-0125438, filed Dec. 16, 2009, the disclosure of which is incorporated herein by reference in its entirety.

### BACKGROUND

1. Field of the Invention

The present invention relates to a voltage-sensitive dye (VSD) required to measure a nerve signal without using an electrode, and more particularly, to a VSD capable of maximizing voltage sensitivity to electrical stimulation through a molecular design and a method of preparing the same.

2. Discussion of Related Art

Recently, due to an ability to measure an action potential of an osmosis membrane optically, the importance of a VSD (merocyanine base or hemicyanine base) has been emphasized. An exemplary VSD, Di-4-ANEPPS (JPW-211), is used in vitro to rapidly dye a cell, and its sensitivity to an electric field is approximately 10% per 100 mV. The method of synthesizing the dye was proposed by Loew in 1984. However, the dye has disadvantages of a short effective measurement time due to photobleaching and necrosis caused by generation of oxygen free radicals under a high electric field.

To resolve these problems of the conventional VSD and improve low fluorescent efficiency due to free rotation such as photoisomerization of the molecular structure of the dye and solubility in an aqueous solution, there have been attempts at changing a moiety connected by a double bond into a single bond and increasing the number of aromatic groups.

However, such VSDs still have complicated synthetic pathways and low yields.

For these reasons, there is a need for a new concept of a VSD to measure brain-nerve electrical stimulation signals.

### SUMMARY OF THE INVENTION

The present invention is directed to a highly effective biocompatible VSD capable of maximizing voltage sensitivity to electrical stimulation by synthesizing a VSD connected by a triple bond through a molecular design, and a method of preparing the same.

One aspect of the present invention provides a VSD, represented by Formula 1:

D-≡-A [Formula 1]

In this formula, D is an electron donor, and A is an electron acceptor.

In the exemplary embodiment, the donor may have a molecular structure including benzene, naphthalene and carbazole.

In the exemplary embodiment, the electron donor may be selected from the group consisting of compounds represented by Formulae 2 to 4:

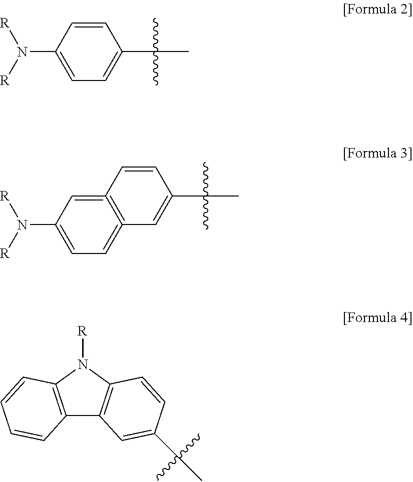

In these formulae, R is a substituted or unsubstituted alkyl group having 1 to 10 carbon atoms.

In the exemplary embodiment, the electron acceptor may have a molecular structure including pyridine.

In the exemplary embodiment, the electron acceptor may be selected from the group consisting of compounds represented by Formulae 5 and 6:

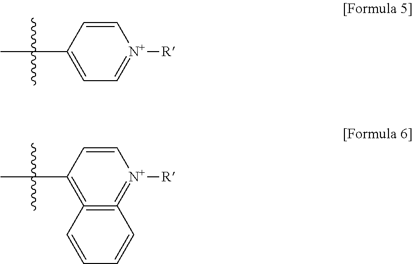

In these formulae, R′ is substituted or unsubstituted —SO₃H, —COOH, —PO₃H or a salt thereof having 1 to 10 carbon atoms.

In the exemplary embodiment, R may be an octyl (C₈H₁₇) group.

The VSD according to the exemplary embodiment of the present invention may be represented by Formula 7:

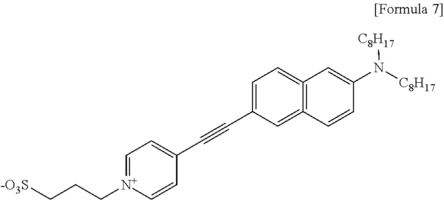

The method of preparing a VSD according to the exemplary embodiment of the present invention is illustrated in Reaction Scheme 1, and includes: (A) preparing Compound 2 by reaction of an NH₂ functional group of Compound 1 with an alkyl halide monomer (RX′); (B) preparing Compound 3 by introducing a triple bond to a halide functional group (X) of Compound 2 through a Sonogashira C—C bond reaction; (C) preparing Compound 4 by reaction of the triple bond protected with an OH functional group of Compound 3 with a base to activate; (D) preparing Compound 5 by coupling a pyridine monomer to Compound 4 through the Sonogashira C—C bond reaction; and (E) synthesizing a VSD by reaction of Compound 5 with Compound 6.

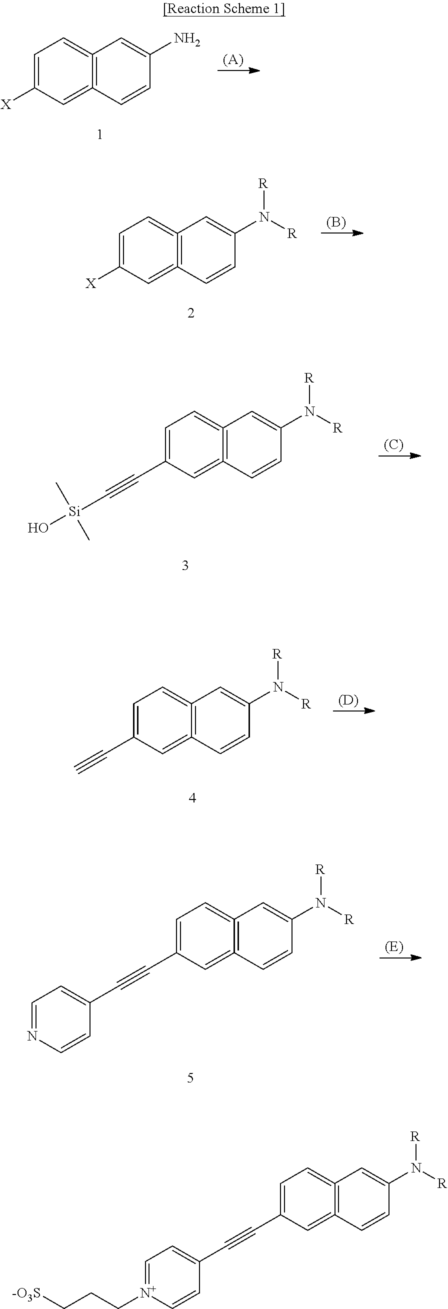

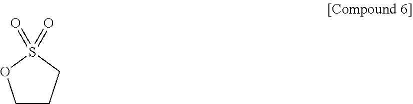

In the formula, R is an alkyl group having 1 to 10 carbon atoms, and each of X and X′ is halogen.

In the exemplary embodiment, R may be an octyl (C₈H₁₇) group.

In the exemplary embodiment, Compound 1 may be prepared by substituting an OH functional group of Compound 7 with NH₂.

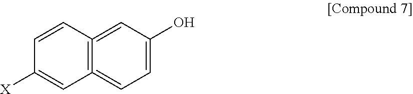

In the exemplary embodiment, X may be Br.

In the exemplary embodiment, X′ may be Br.

In the exemplary embodiment, the base of operation (C) may be NaOH.

### BRIEF DESCRIPTION OF THE DRAWINGS

The above and other objects, features and advantages of the present invention will become more apparent to those of ordinary skill in the art by describing in detail preferred embodiments thereof with reference to the attached drawings in which:

FIG. 1 is a diagram of a schematic structure of a VSD according to an exemplary embodiment of the present invention;

FIG. 2 is a diagram illustrating a method of preparing a VSD according to an exemplary embodiment of the present invention;

FIG. 3 is a graph showing a spectroscopic characteristic of a VSD according to an exemplary embodiment of the present invention;

FIG. 4A is a diagram showing sensitivity of the conventional VSD according to an external voltage; and

FIG. 4B is a diagram showing sensitivity of the VSD of the exemplary embodiment of the present invention according to an external voltage.

### DETAILED DESCRIPTION OF EXEMPLARY EMBODIMENTS

Hereinafter, the present invention will be described with reference to the accompanying drawings in detail. This invention may, however, be embodied in different forms and should not be construed as limited to the exemplary embodiments set forth herein. Rather, these embodiments are provided so that this disclosure will be thorough and complete, and will fully convey the scope of the invention to those skilled in the art. Like numbers refer to like elements throughout the specification. In the drawings, the thickness of layers and regions are exaggerated for clarity.

Throughout the specification, when a part is said to “include” an element, unless otherwise specified, other elements are not excluded but may be further included.

The present invention relates to a method of preparing a VSD required to measure brain-nerve electrical stimulation signals, and more particularly, to development of a biocompatible VSD directly related to an electric action characteristic of a nerve cell and a fluorescence recording technique on the basis thereof. To this end, a VSD connected by a triple bond is synthesized through a molecular design and a dynamic spectroscopic characteristic is measured to analyze a relationship between a diopole moment in a ground state and the sensitivity to electrical stimulation.

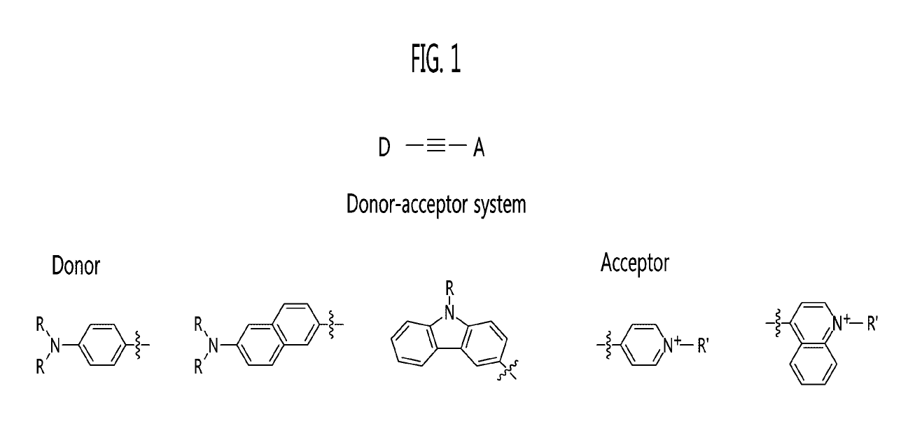

FIG. 1 is a schematic diagram of a structure of a VSD according to an exemplary embodiment of the present invention.

Referring to FIG. 1, the exemplary embodiment of the present invention provides a VSD represented by Formula 1:

D-≡-A [Formula 1]

In the formula, D is an electron donor, and A is an electron acceptor.

The electron donor (D) may have a molecular structure including benzene, naphthalene, and carbazole.

More specifically, the electron donor (D) may be selected from the group consisting of compounds represented by Formulae 2 to 4:

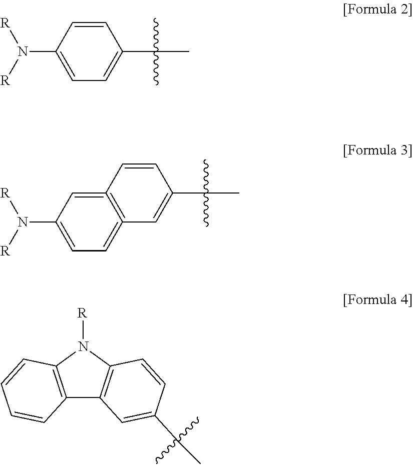

In these formulae, R is a substituted or unsubstituted alkyl group having 1 to 10 carbon atoms.

The electron acceptor (A) may have a molecular structure including pyridine. More specifically, the electron acceptor (A) may be selected from the group consisting of compounds represented by Formulae 5 and 6:

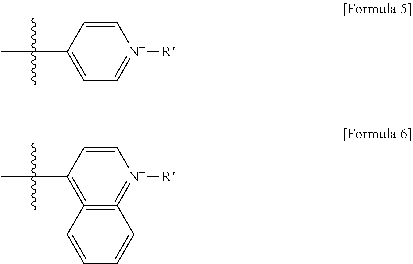

In these formulae, R′ is substituted or unsubstituted —SO₃H, —COOH, —PO₃H or a salt thereof having 1 to 10 carbon atoms.

The VSD according to the exemplary embodiment of the present invention may be a VSD (ETRI-Di-8) represented by Formula 7:

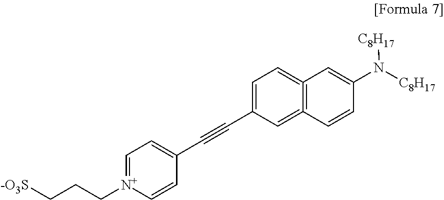

When the electron donor (D) is coupled to the electron acceptor (A) by a triple bond, a free rotation rate of the molecular structures of the electron acceptor (A) and the electron donor (D) of the VSD is decreased (e.g., photoisomerization), and fluorescence efficiency and voltage sensitivity to electrical stimulation may be increased.

Here, an overall compound structure of the present invention formed by the design of the molecular structure is shown. Thus, even if there is a different combination of a donor-acceptor system, it will be understood as the method of preparing the dye using the same components.

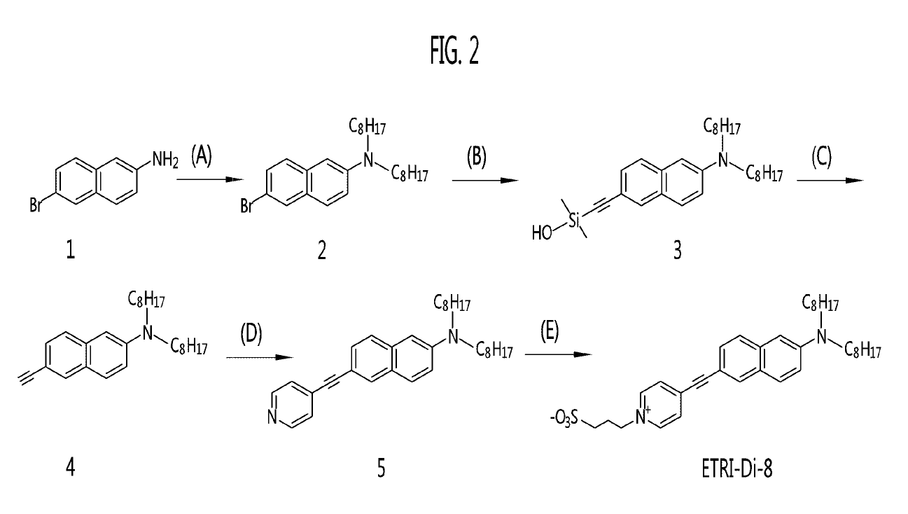

FIG. 2 is a diagram illustrating a method of preparing a VSD according to an exemplary embodiment of the present invention.

Referring to FIG. 2, the method of preparing a VSD according to the exemplary embodiment of the present invention is illustrated by Reaction Scheme 1:

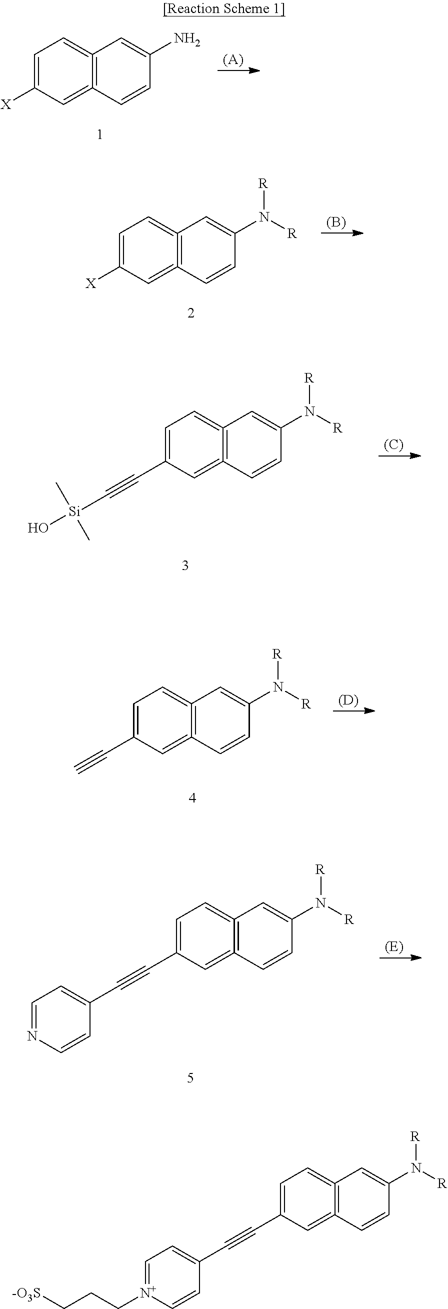

To begin with, an OH functional group of 6-bromo-2-hydroxynaphthalene (or 6-bromo-2-naphtol (CAS number: 15231-91-1)) is substituted with NH₂ to prepare Compound 1.

Subsequently, the NH₂ functional group of Compound 1 reacts with an alkyl halide (RX′) (e.g., bromoalkyl) monomer to prepare Compound 2 (A).

In Reaction Scheme 1, as an alkyl group of the alkyl halide, an octyl group (C₈H₁₇) is used, but the present invention is not limited thereto.

Then, a triple bond is introduced to a halide functional group (X) of Compound 2 through a Sonogashira C—C bond reaction to prepare Compound 3 (B).

In Reaction Scheme 1, as the halide functional group (X) of Compound 2, Br is used, but the present invention is not limited thereto.

Afterwards, the triple bond protected with a hydroxyl group (—OH) of Compound 3 reacts with a base (e.g., NaOH) to activate, thereby preparing Compound 4 (C).

Then, Compound 4 is coupled to a pyridine monomer through Sonogashira C—C bond reaction to prepare Compound 5 (D).

Afterwards, Compound 5 reacts with a monomer of Compound 6, 1,3-propane sultone, to synthesize a VSD represented by Formula 7 (E).

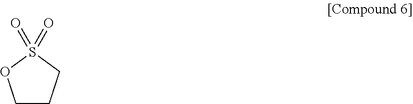

In Reaction Scheme 1, R is a substituted or unsubstituted alkyl group having 1 to 10 carbon atoms, and preferably an octyl group (C₈H₁₇) as described above.

X and X′ are halogen, and preferably Br.

Hereinafter, the VSD according to the present invention will be described in further detail with reference to Examples. However, it should be understood by one of ordinary skill in the art that the scope of the present invention is not limited to the examples.

### Example 1

### Synthesis of Compound 1 (6-bromo-2-naphthylamine)

4.5 g (90%); m.p. 126-127° C. (lit. 128° C.); ¹H NMR (300 MHz, CDCl₃, ppm) δ 7.83 (J=1.2 Hz, d, 1H), 7.58 (J=8.4 Hz, d, 1H), 7.47 (J=8.4 Hz, d, 1H), 7.43 (J=8.7 Hz, J=1.8 Hz, dd, 1H), 6.97 (J=2.4 Hz, d, 1H), 6.94 (s, 1H), 3.88 (brs, 1H)

### Example 2

### Synthesis of Compound 2 (6-Bromo-2-(di-n-octylamino)naphthalene)

6-bromo-2-naphthylamine (2.5 g, 11.26 mmol), 1-iodooctane (5.02 mL, 33.77 mmol), and K₂CO₃ (3.89 g, 28.14 mmol) were added to 15 mL of anhydrous dimethylformamide, and then the resulting mixture was refluxed and stirred for 24 hours.

The reaction product was extracted with dichloromethane (CH₂Cl₂) three times and isolated using a column (eluting solvent=hexane) in a yield of 90% (4.5 g); ¹H NMR (300 MHz, CDCl₃, ppm) δ 7.77 (J=1.5 Hz, d, 1H), 7.57 (J=9.0 Hz, d, 1H), 7.47 (J=9.0 Hz, d, 1H), 7.38 (J=9.0 Hz, J=2.1 Hz, dd, 1H), 7.07 (9.3 Hz, J=2.7 Hz, dd, 1H), 6.74 (J=2.4 Hz, d, 1H), 3.33 (t, 4H), 1.61 (m, 4H), 1.23-1.42 (m, 20H), 0.89 (t, 6H); ¹³C NMR (75 MHz, CDCl₃, ppm) δ 146.19, 133.62, 129.12, 129.06, 127.76, 127.39, 126.87, 116.37, 114.07, 104.60, 51.14, 31.92, 29.58, 29.43, 27.37, 27.24, 22.75, 14.22

### Example 3

### Synthesis of Compound 3

6-Bromo-2-(di-n-octylamino) naphthalene (2.0 g, 4.479 mmol), Pd(PPh₃)₂Cl₂ (35.4 mg, 0.045 mmol), 2-methyl-3-butyn-2-ol (0.7 mL, 7.167 mmol), CuI (85.4 mg, 0.448 mmol), and PPh₃ (0.12 g, 0.448 mmol) were added to a reaction container containing 60 ml of NEt₃, and then the resulting mixture was refluxed and stirred for 24 hours. Thereby, 15 g of a reaction product was obtained in a yield of 72%; ¹H NMR (300 MHz, CDCl₃, ppm) δ 7.75 (J=1.5 Hz, d, 1H), 7.61 (J=9.0 Hz, d, 1H), 7.51 (J=9.0 Hz, d, 1H), 7.33 (J=9.0 Hz, J=1.8 Hz, dd, 1H), 7.05 (9.3 Hz, J=2.7 Hz, dd, 1H), 6.74 (J=2.4 Hz, d, 1H), 3.35 (t, 4H), 2.05 (s, 1H), 1.61-1.65 (m, 10H), 1.25-1.42 (m, 20H), 0.89 (t, 6H); ¹³C NMR (75 MHz, CDCl₃, ppm) δ 146.39, 134.58, 130.99, 128.57, 125.53, 125.14, 115.79, 114.66, 104.49, 92.50, 90.29, 83.09, 51.00, 31.78, 29.45, 29.30, 27.63, 27.11, 22.65, 14.19

### Example 4

### Synthesis of Compound 4

Compound 3 (1.35 g, 2.898 mmol) and NaOH (0.58 g, 14.492 mmol) were added to a reaction container containing 15 ml of toluene, and then the reaction mixture was refluxed and stirred for 12 hours. After the reaction, a reaction product was isolated using a column (eluting solvent ═CH₂Cl₂) in a yield of 88% (1.0 g); ¹H NMR (300 MHz, CDCl₃, ppm) δ 7.83 (J=1.5 Hz, d, 1H), 7.62 (J=9.0 Hz, d, 1H), 7.52 (J=9.0 Hz, d, 1H), 7.38 (J=9.0 Hz, J=1.8 Hz, dd, 1H) 7.06 (9.3 Hz, J=2.7 Hz, dd, 1H), 6.75 (J=2.4 Hz, d, 1H), 3.35 (t, 4H), 3.06 (s, 1H), 1.61-1.65 (m, 4H), 1.25-1.42 (m, 20H), 0.89 (t, 6H); ¹³C NMR (75 MHz, CDCl₃, ppm) δ 146.64, 134.95, 131.79, 128.67, 125.63, 125.03, 115.89, 113.92, 104.50, 84.92, 76.00, 51.04, 31.89, 29.55, 29.40, 27.34, 27.18, 22.72, 14.19

### Example 5

### Synthesis of Compound 5

Compound 4 (0.7 g, 2.505 mmol), Pd(PPh₃)₂Cl₂ (59 mg, 0.075 mmol) 4-bromopyridine (0.63 g, 3.26 mmol), CuI (48 mg, 0.251 mmol), and PPh₃ (66 mg, 0.251 mmol) were added to a reaction container containing 60 ml of NEt₃, and then the resulting mixture was refluxed and stirred for 24 hours. Thereby, 0.7 g of a reaction product was obtained in a yield of 78%; ¹H NMR (300 MHz, CDCl₃, ppm) δ 8.56 (J=5.7 Hz, d, 2H), 7.90 (s, 1H), 7.66 (J=9.0 Hz, d, 1H), 7.57 (J=9.0 Hz, d, 1H), 7.44 (J=6.9 Hz, J=1.5 Hz, dd, 1H), 7.39 (J=9.0 Hz, J=1.8 Hz, d, 2H), 7.09 (J=6.3 Hz, J=2.7 Hz, dd, 1H), 6.77 (J=2.1 Hz, d, 1H), 3.33 (t, 4H), 1.61 (m, 4H), 1.23-1.42 (m, 20H), 0.89 (t, 6H); ¹³C NMR (75 MHz, CDCl₃, ppm) δ 149.37, 146.88, 135.17, 131.86, 128.85, 128.33, 125.78, 125.18, 115.95, 113.64, 104.38, 95.82, 85.74, 51.04, 31.89, 29.55, 29.40, 27.34, 27.18, 22.72, 14.19

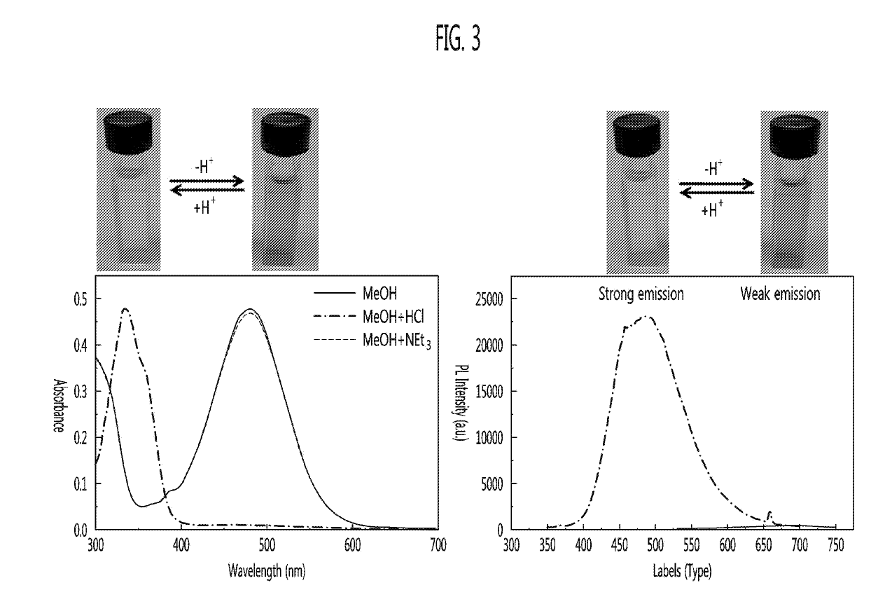

FIG. 3 is a graph showing a spectroscopic characteristic of a VSD according to an exemplary embodiment of the present invention.

Referring to FIG. 3, the VSD has a maximum absorption wavelength at 470 nm and exhibits a very weak fluorescence characteristic at room temperature. The dye disclosed in the present invention is changed in absorbance and fluorescence characteristics according to pH, and thus can be applied as a biosensor.

The VSD according to an exemplary embodiment of the present invention does not exhibit a fluorescence characteristic when electron stimulation is not provided but exhibits a fluorescence characteristic when electrical stimulation is provided, which is opposite to the conventional dye.

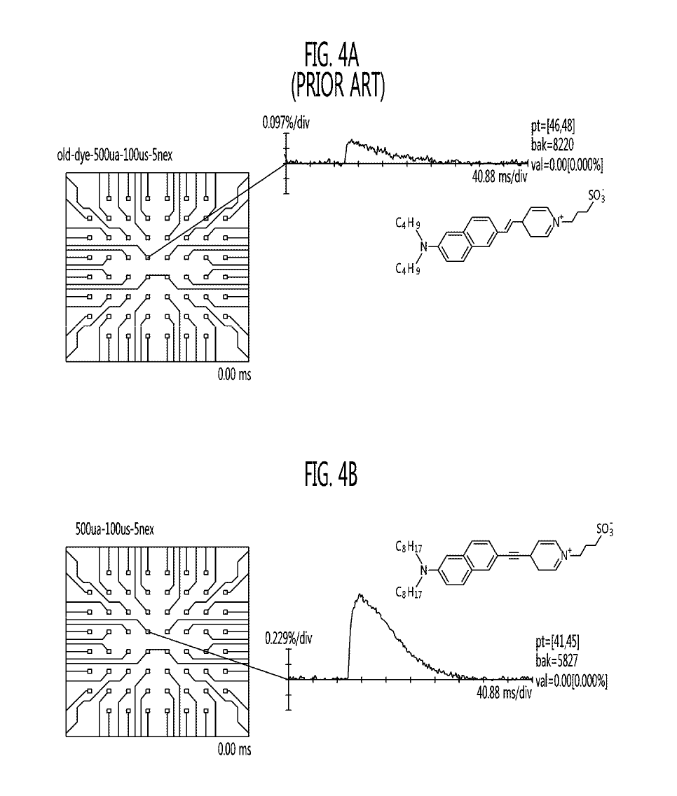

FIG. 4A is a diagram showing sensitivity of the conventional

VSD according to an external voltage, and FIG. 4B is a diagram showing sensitivity of the VSD of the exemplary embodiment of the present invention according to an external voltage.

Referring to FIGS. 4A and 4B, sensitivities according to a voltage between the conventional VSD (Di-4-ANEPPS) in FIG. 4A and the VSD according to the exemplary embodiment of the present invention (ETRI-Di-8) in FIG. 4B are compared (electrical stimulation=500 mA).

Referring to FIGS. 4A and 4B, in the VSD according to the exemplary embodiment of the present invention, an electron donor is coupled to an electron acceptor by a triple bond, whereas in Di-4-ANEPPS, the electron donor is coupled to the electron acceptor by a double bond.

The VSD according to the exemplary embodiment of the present invention exhibits improved voltage sensitivity, which is three times that of Di-4-ANEPPS.

As described above, when the electron donor (D) is coupled to the electron acceptor (A) by the triple bond, the free rotation rate of the molecular structures of the electron donor (D) and the electron acceptor (A) is decreased (e.g., photoisomerization), which is because the fluorescence efficiency and voltage sensitivity to electrical stimulation are increased.

As described above, the present invention relates to the VSD required to measure a brain-nerve electrical stimulation signal and a method of preparing the same. The VSD can improve voltage sensitivity to external electrical stimulation due to its molecular structure design.

The exemplary embodiments of the present invention are not limited to the device and method described above, but will be easily accomplished by those of ordinary skill in the art based on the above description.

By using a VSD according to the exemplary embodiment of the present invention, an electron donor (D) and an electron acceptor (A) are coupled to each other by a triple bond due to a molecular structure design of the dye. Accordingly, a free rotation rate of the molecular structures of the electron donor (D) and the electron acceptor (A) is decreased (e.g., photoisomerization), and thus fluorescence efficiency and voltage sensitivity to external electrical stimulation can be improved.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A voltage sensitive dye (VSD) represented by Formula 1:
D-≡-A[Formula 1]
where D is an electron donor, and A is an electron acceptor.

2. The VSD according to claim 1, wherein the electron donor has a molecular structure including benzene, naphthalene, and carbazole.

3. The VSD according to claim 1, wherein the electron donor is selected from the group consisting of compounds represented by Formulae 2 to 4: 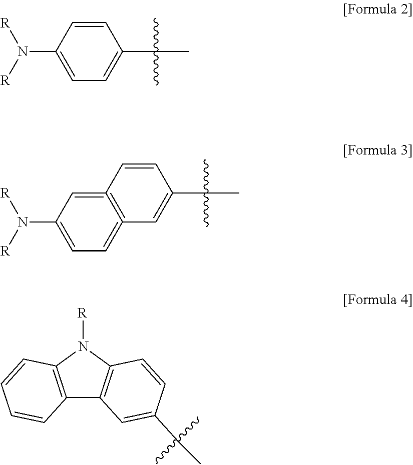
where R is a substituted or unsubstituted alkyl group having 1 to 10 carbon atoms.

4. The VSD according to claim 1, wherein the electron acceptor has a molecular structure including pyridine.

5. The VSD according to claim 1, wherein the electron acceptor is selected from the group consisting of compounds represented by Formulae 5 and 6: 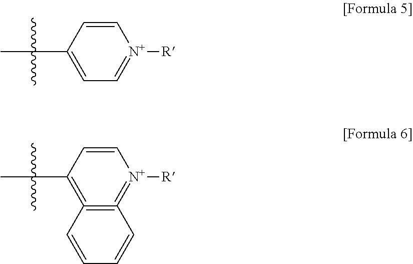
where R′ is substituted or unsubstituted —SO₃H, —COOH, —PO₃H or a salt thereof having 1 to 10 carbon atoms.

6. The VSD according to claim 3, wherein R is an octyl (C₈H₁₇) group.

7. A VSD represented by Formula 7:

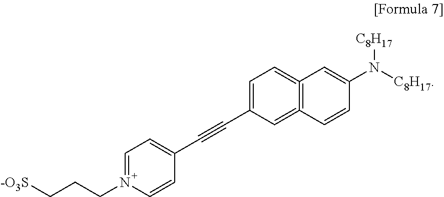

8. A method of preparing a voltage sensitive dye (VSD) illustrated in Reaction Scheme 1, comprising:
(A) preparing Compound 2 by reaction of an NH₂ functional group of Compound 1 with an alkyl halide monomer (RX′);
(B) preparing Compound 3 by introducing a triple bond to a halide functional group (X) of Compound 2 through a Sonogashira C—C bond reaction;
(C) preparing Compound 4 by reaction of the triple bond protected with an OH functional group of Compound 3 with a base to activate;
(D) preparing Compound 5 by coupling a pyridine monomer to Compound 4 through the Sonogashira C—C bond reaction; and
(E) synthesizing a VSD by reaction of Compound 5 with Compound 6, 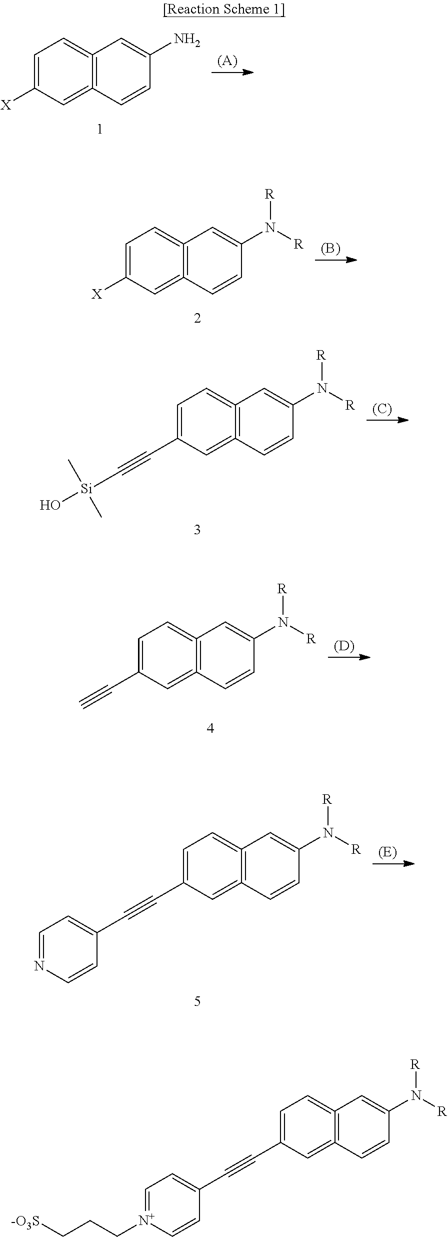 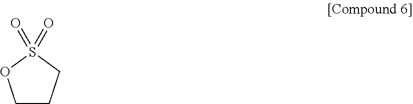
where R is an alkyl group having 1 to 10 carbon atoms, and each of X and X′ is halogen.

9. The method according to claim 8, wherein R is an octyl (C₈H₁₇) group.

10. The method according to claim 8, wherein Compound 1 is prepared by substituting an OH functional group of Compound 7 with NH₂:

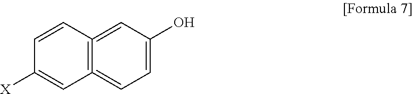

11. The method according to claim 8, wherein X is Br.

12. The method according to claim 8, wherein X′ is Br.

13. The method according to claim 10, wherein X is Br.

14. The method according to claim 8, wherein the base of operation (C) is NaOH.
